(19) United States
(12) Patent Application Publication
(10) Pub. No.: US 2018/0105307 A1
(43) Pub. Date: Apr. 19, 2018

(54) WRAPPING MACHINE WITH SELF-CALIBRATION

(71) Applicant: ILLINOIS TOOL WORKS INC., Glenview, IL (US)

(72) Inventor: Juan C. Guzman, Dayton, OH (US)

(21) Appl. No.: 15/482,047

(22) Filed: Apr. 7, 2017

Related U.S. Application Data
(60) Provisional application No. 62/408,118, filed on Oct. 14, 2016.

(51) Int. Cl. B65B 59/02; B65B 57/12; B65B 11/48; B65B 41/12; B65B 45/00; B65C 1/02

(52) U.S. Cl. CPC B65B 59/02; B65B 57/12; B65C 1/02; B65B 41/12; B65B 45/00; B65B 11/48

(57) ABSTRACT

A wrapping machine for wrapping trayed items includes a wrap station and a conveying system for moving trayed items from an input station to the wrap station. The conveying system includes a conveyor for moving trayed items from the input station to a trayed item detection arrangement, and a prime mover operatively connected for moving the conveyor. A controller connected to the trayed item detection arrangement and the prime mover is configured for selectively carrying out a self-calibration operation in which: the prime mover is operated to cause movement of a portion of the conveyor from a start position to the trayed item detection arrangement; and an amount of prime mover movement required for the portion to travel from the start position to the trayed item detection arrangement is monitored and used to store a calibration value in memory of the controller.

### TECHNICAL FIELD

This application relates generally to wrapping machines used for wrapping food items and, more specifically, to a wrapping machine with an associated self-calibration process.

### BACKGROUND

Packaging machines are frequently used to automatically wrap film about products, such as trayed food items. The packaging machines typically include a film gripper that grips and pulls the film from a roll of film, side clamps that grip the film, and folders that fold the film underneath the product. Various control systems and sensors may be employed, for example, to control operation of the gripper and to sense product location. It is generally desirable to know the length of the product tray so that wrap parameters will properly accommodate the particular tray size.

In the past, in order to calibrate a machine infeed so as to enable proper determination of tray size being used, a service technician had to place a tray on the infeed station and manually enter tray size information for the tray being used on the machine interface. The package wrapping machine could then calibrate the infeed length of the machine for the purpose of the calibration. This methodology enabled errors to be introduced if the technician fails to input accurate tray size information during the calibration.

It would be desirable to provide an automated wrapping machine with a calibration methodology that does not require the use of a tray and/or that does not require user input of a tray size or dimension.

### SUMMARY

In one aspect, a wrapping machine for wrapping trayed food products includes a wrap station at which trayed food products are wrapped, a film dispensing system for drawing out film at the wrap station and a conveying system for moving trayed food products along a defined path from an input station to the wrap station. The conveying system includes a conveyor for moving trayed food products from the input station to a trayed item detection arrangement, and a prime mover operatively connected for moving the conveyor. A controller is operatively connected to the trayed item detection arrangement and the prime mover. The controller is configured for carrying out a self-calibration operation in which: the prime mover is operated to cause movement of a portion of the conveyor from a start position to the trayed item detection arrangement; an amount of movement of the prime mover is monitored as the portion travels from the start position to the trayed item detection arrangement and the amount of movement is used to determine a distance from the start position to the trayed item detection arrangement; and the determined distance is stored as a calibration value in memory of the controller for future use during trayed food product wrapping operations.

In another aspect, a wrapping machine for wrapping trayed items includes a wrap station at which film is wrapped around trayed items, and a conveying system for moving trayed items along a defined path from an input station to the wrap station. The conveying system includes a conveyor for moving trayed items from the input station to a trayed item detection arrangement, and a prime mover operatively connected for moving the conveyor. A controller is operatively connected to the trayed item detection arrangement and the prime mover. The controller is configured for selectively carrying out a self-calibration operation in which: the prime mover is operated to cause movement of a portion of the conveyor from a start position to the trayed item detection arrangement; and an amount of movement of the prime mover required for the portion to travel from the start position to the trayed item detection arrangement is monitored and used to store as a calibration value in memory of the controller for future use during trayed item wrapping operations.

In a further aspect, a method is provided for calibrating a package wrapping machine that includes a conveyor for moving trayed items from an infeed station toward a wrap station, and the machine further including a controller for controlling operation of the machine. The method involves the controller: monitoring an indicator of motor rotation of a motor that drives the conveyor as a portion of the conveyor is moved from a first position to a second position; and utilizing the indicator to store a calibration value for future use during trayed item wrapping operations.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a perspective front view of a wrapping machine;

FIG. 2 is a side elevation of the wrapping machine;

FIG. 3 is a schematic side view showing product movement through the machine during wrapping;

FIG. 4 is a schematic side view of an intake area of a wrapping machine;

FIG. 5 is a schematic side view per FIG. 4 with a trayed item shown;

FIG. 6 is a partial perspective of an intake are; and

FIG. 7 shows a distance formed in part by a linear path and in part by an arcuate path.

### DETAILED DESCRIPTION

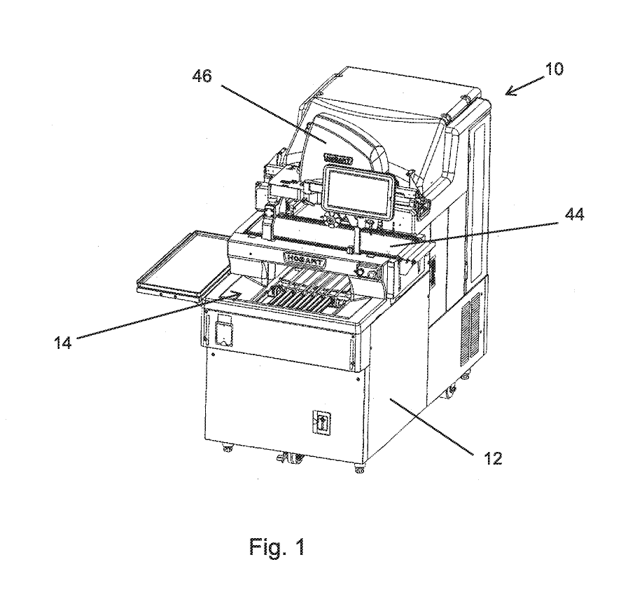

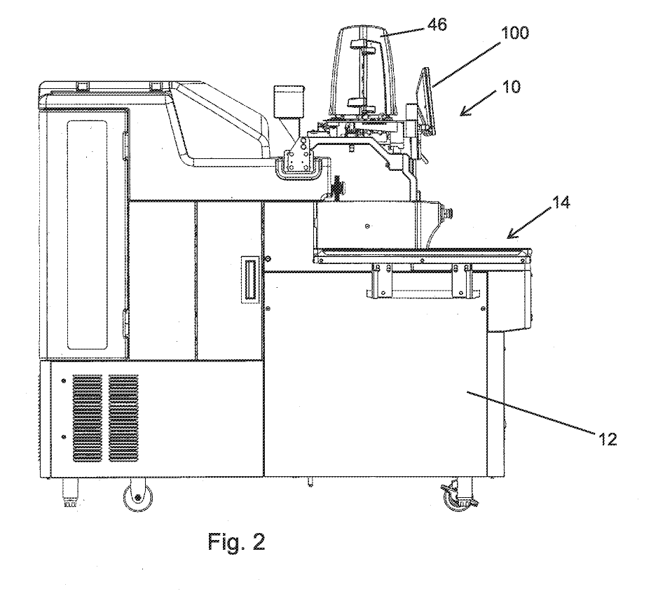

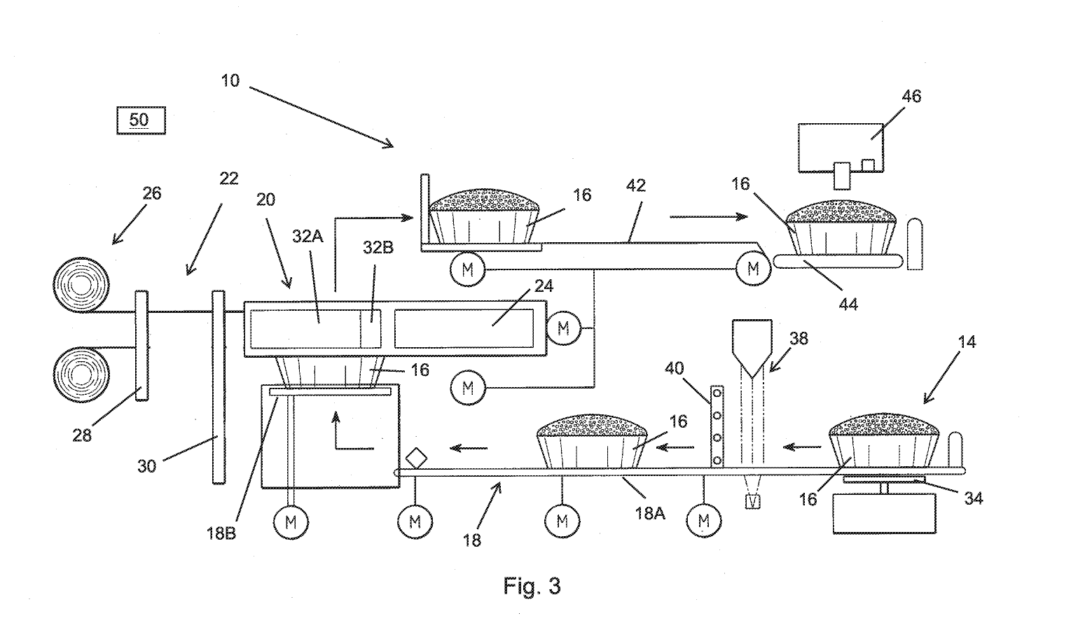

Referring to FIGS. 1-3, a food product wrapping machine 10 includes an inner frame and outer housing 12. An inlet area 14 provides a location at which products to be wrapped (e.g., food items 16, such as meats in trays) are input to the machine for wrapping in plastic film. The inlet area 14 is part of a conveying system 18 that carries packages into the machine (right to left in FIGS. 2 and 3) and then up into a wrap station 20 at which the food products are wrapped. Here the conveying system includes one or more horizontal conveyors 18A that feed from the front of the machine back to an elevator mechanism 18B. A film dispensing system 22 is provided for drawing out film over food products at the wrap station 20 (e.g., under control of a film gripper 24 that moves left to right in FIG. 3 in order to draw off film from one or more film rolls 26). Where more than one film roll is provided (e.g., of differing film widths), an actuatable film selector 28 provides the ability to select the desired film for a given wrap operation (e.g., depending upon size of the food product). An actuatable film knife 30 is provided to cut the film at the appropriate time to enable the wrap operation to be completed. The wrap station may include side clamps 32A, 32B to grip the lateral sides of the film, as well as side underfolders and a rear underfolder (not shown).

A weighing mechanism 34 is located at the inlet area for weighing the food product as it is placed into the machine. Once a stable weight is determined, the food product 16 is moved laterally into the machine through a light curtain imaging system 38 and past a height sensor array 40 for determining size of the food product and location of the food product on the conveyor. Part of the horizontal conveying system 18A may be shifted (e.g., into or out of the page in FIG. 3) as necessary to assure that the food product is properly centered when it is transferred onto the elevator mechanism 18B. After the food product is moved up into the wrap station 20 and wrapped, the wrapped food product is conveyed by a conveyor 42 back toward the front of the machine and deposited onto another horizontal conveyor 44, which here moves left or right (into or out of the page in FIG. 3). The conveyor 42 includes an associated sealer belt that heats the bottom of the wrapped food product to seal the film, and a label printing mechanism 46 prints and applies a pricing label to the wrapped food product. An exemplary controller 50 is shown for controlling machine operation. As used herein, the term controller is intended to broadly encompass any circuit (e.g., solid state, application specific integrated circuit (ASIC), an electronic circuit, a combinational logic circuit, a field programmable gate array (FPGA)), processor(s) (e.g., shared, dedicated, or group—including hardware or software that executes code), software, firmware and/or other components, or a combination of some or all of the above, that carries out the control functions of the machine or the control functions of any component thereof.

Various motors M are shown and are used primarily for movement of the conveyor components, gripper components and underfolders. However, a plurality of pneumatic components are also provided for control of components, where each pneumatic component is actuatable by delivery of pressurized air.

For the purpose of the above wrap operation, understanding the size of the trayed item being wrapped is helpful to assure proper wrap, as certain wrap parameters, such as length of film pull, can be set based upon the size. For this reason, the machine controller automatically determines tray size each time a tray feeds into the machine, and responsively sets one or more wrap parameters. To enable the machine to accurately determine tray size, a self-calibration operation is carried out by the machine. The self-calibration operation may be carried out as part of machine set-up process and triggered via a user interface of the machine that implements a self-calibration mode, described in further detail below.

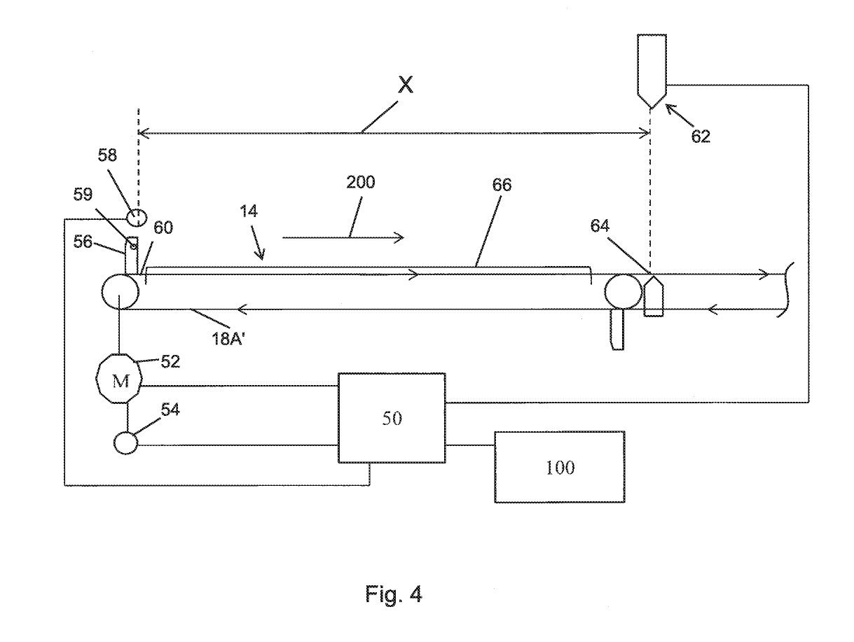

Referring now to the schematic side view of FIG. 4, an exemplary infeed section of the machine is shown and includes a conveyor 18A′ for moving trayed items in an infeed direction 200 from the infeed station 14 toward the downstream wrap station (not shown), and the controller 50 is also shown. A prime mover (e.g., drive motor) 52 is connected for moving the conveyor 18A′. The motor 52 includes an associated encoder (e.g., a rotary Hall-type encoder) 54 to monitor rotation of the motor. The conveyor 50 includes one or more push lugs 56 to push trayed items, a sensor arrangement 58 for detecting location of the push lug at an upstream position 60 and another sensor arrangement 62 for detecting location of the push lug a downstream location 64. By way of example, sensor arrangement 58 may be a Hall-type sensor that is located to detect a magnet 59 on the push lug 56, and sensor arrangement 62 may be an optical sensor (e.g., in the form of a light beam or light curtain that will be broken by the lug when the lug reaches position 64). Here, the sensor arrangement 62 is shown as the light curtain imaging system depicted as 38 in FIG. 3, but the sensor arrangement 62 could be the height detector depicted as 40 in FIG. 3. The infeed station 14 includes a set of laterally spaced apart rails 66 along which trayed food items slide as the trayed food items are pushed by a set of the lugs 56. The rails 66 may form part of the weighing mechanism 34 for the trayed items.

The controller 50 receives inputs from both sensor arrangements 58 and 62, as well as the encoder 54, and is connected to control operation of the motor 52. The controller may also be connected to a user interface 100 (e.g., a touch-screen display) that enables service personnel to select a calibration mode of the machine. In the calibration mode, the controller 50 carries out a calibration operation to determine an infeed length dimension, more particularly the distance X from the position 60 to position 64.

During the calibration operation the prime mover 52 is operated to cause movement of the lug 56 from position 58 to position 64. Movement of the prime mover is monitored based upon output from sensor 54 in order to determine the distance X from the position 60 to the position 64. The determined distance X is then stored as a calibration value in memory of the controller 50 for future use during trayed food product wrapping operations.

In the illustrated embodiment, the portion of the conveyor detected is the push lug 56, but in other embodiments some other part of the conveyor 18A′ could be detected by sensor arrangements 58 and 62. Where the encoder 54 is used to detect rotary movement of the motor 52, the controller 50 counts a number encoder pulses/ticks output by the rotary encoder 54 to move the push lug 56 from the position 60 to the position 64. The controller 50 then determines the distance X by multiplying the counted number of encoder pulses (e.g., A pulses) by a predefined, known distance per pulse (e.g., B mm/pulse). Thus, once the pulse/tick count A is obtained, the distance X is calculated by the controller 50 as:

X=(A pulses) (B mm/pulse)

Notably, the calibration is carried out without conveying any trayed item on the conveyor 18A′ and without requiring a service person to input any tray size information to the user interface 100 of the machine.

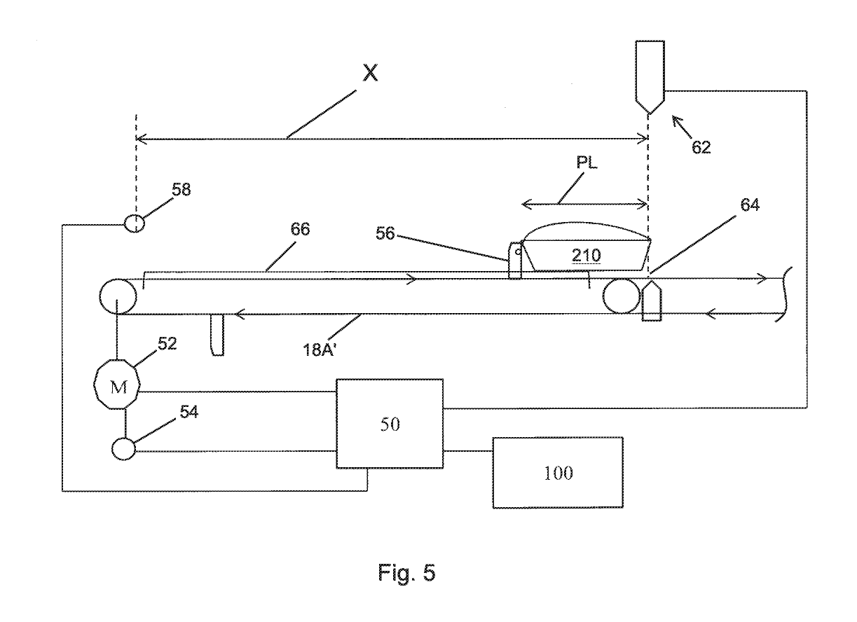

By storing the determined distance X in memory, the controller 50 can later use that stored dimension during wrap operations to determine the actual length of a package (trayed item 210) as it is conveyed along the conveyor 18A′. In particular, by counting the number of pulses from when the lug 56 is at position 60 to when the leading edge of a package reaches position 64 as shown in FIG. 5 (e.g., assume a count of C pulses), the controller 50 then calculates package length dimension PL as:

PL=X−[(C pulses)(B mm/pulse)].

This calculation can be carried out for each trayed item fed into the machine during high speed wrapping operations.

In an alternative implementation, rather than calculate dimension X, the controller 50 may be configured to simply store the pulse count A as the calibration value. In such cases, the controller 50 can calculate package length dimension for each package as:

PL=(A−[(C pulses)(B mm/pulse)].

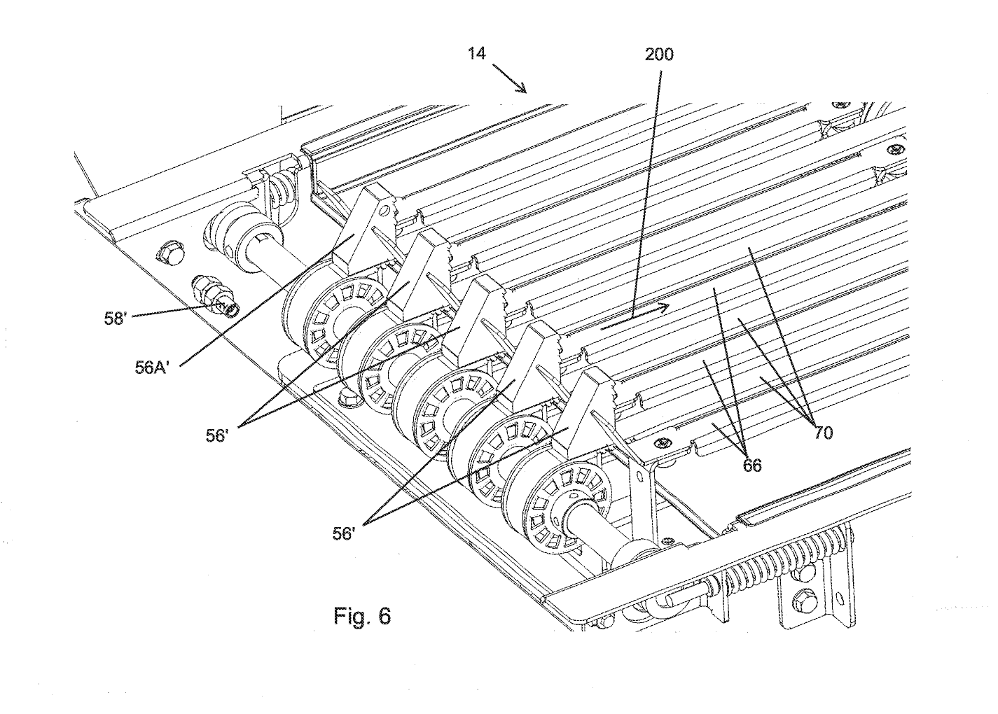

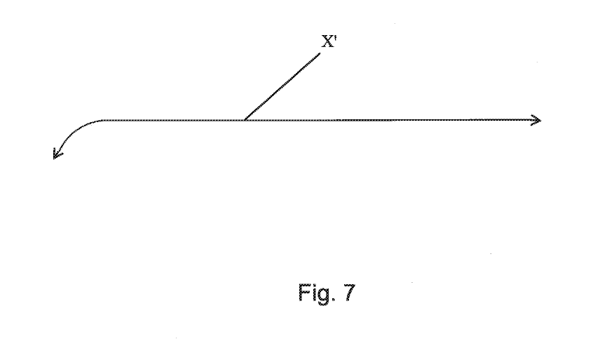

Referring now to FIG. 6, a partial perspective view of one embodiment of an infeed station 14 is shown, with a set of lugs 56′ connected to respective belts 70 movable in direction 200, and with spaced apart trayed item support rails 66. Here, the sensor 58′ for detecting an end lug 56A′ of the lug set is located along the arcuate portion of the travel path of the lug. As seen in FIG. 7, in this arrangement the calculated dimension (here X′) would include part of the arcuate travel path. However, this does not impact the overall effectiveness of the calibration operation.

It is to be clearly understood that the above description is intended by way of illustration and example only, is not intended to be taken by way of limitation, and that other changes and modifications are possible.

What is claimed is:

1. A wrapping machine for wrapping trayed food products, comprising:
a wrap station at which trayed food products are wrapped;
a film dispensing system for drawing out film at the wrap station;
a conveying system for moving trayed food products along a defined path from an input station to the wrap station, wherein the conveying system includes a conveyor for moving trayed food products from the input station to a trayed item detection arrangement, and a prime mover operatively connected for moving the conveyor;
a controller operatively connected to the trayed item detection arrangement and the prime mover, the controller configured for carrying out a self-calibration operation in which:
the prime mover is operated to cause movement of a portion of the conveyor from a start position to the trayed item detection arrangement;
an amount of movement of the prime mover is monitored as the portion travels from the start position to the trayed item detection arrangement and the amount of movement is used to determine a distance from the start position to the trayed item detection arrangement; and
the determined distance is stored as a calibration value in memory of the controller for future use during trayed food product wrapping operations.

2. The machine of claim 1 wherein the prime mover is a motor and an encoder is used to monitor the amount of movement of the motor.

3. The machine of claim 2 wherein the encoder is a Hall-based rotary encoder.

4. The machine of claim 2 wherein the portion of the conveyor is a push lug.

5. The machine of claim 4 wherein the controller determines that the push lug is at the start position based upon an input from a Hall-type sensor that is positioned to detect movement of the push lug by the start position.

6. The machine of claim 5 wherein the trayed item detection arrangement includes a optical sensor and the controller determines that the push lug has reached the trayed item detection arrangement via an input from the optical sensor.

7. The machine of claim 6 wherein the controller is configured to determine the distance by (i) counting a number of encoder ticks that it takes for the push lug to move from the start position to the trayed item detection arrangement and (ii) multiplying the counted number of encoder ticks by a predefined distance per tick.

8. The machine of claim 7 wherein during an actual wrap operation for a trayed food product a trailing edge of the trayed food product is pushed by the push lug in order to move the trayed food product from the input station toward the trayed item detection arrangement, wherein the controller is configured to utilize the determined distance during the actual wrap operation in order to calculate a conveying direction dimension of the trayed food product, and the conveying direction dimension affects at least one subsequent wrap parameter implemented for the trayed food product.

9. The machine of claim 1 wherein the controller is configured such that the self-calibration operation is carried out when a user interface of the machine is used to trigger a self-calibration mode of the machine.

10. A wrapping machine for wrapping trayed items, comprising:
a wrap station at which film is wrapped around trayed items;
a conveying system for moving trayed items along a defined path from an input station to the wrap station, wherein the conveying system includes a conveyor for moving trayed items from the input station to a trayed item detection arrangement, and a prime mover operatively connected for moving the conveyor;
a controller operatively connected to the trayed item detection arrangement and the prime mover, the controller configured for selectively carrying out a self-calibration operation in which:
the prime mover is operated to cause movement of a portion of the conveyor from a start position to the trayed item detection arrangement;
an amount of movement of the prime mover required for the portion to travel from the start position to the trayed item detection arrangement is monitored and used to store a calibration value in memory of the controller for future use during trayed item wrapping operations.

11. The machine of claim 10 wherein the prime mover is a motor and an encoder is used to monitor the amount of movement of the motor, wherein the controller is configured to count a number of encoder ticks that it takes for the portion to move from the start position to the trayed item detection arrangement, and the number of encoder ticks is used to set the calibration value.

12. The machine of claim 11 wherein the calibration value is one of (i) the counted number of encoder ticks or (ii) a distance determined by multiplying the counted number of encoder ticks by a predefined distance per tick.

13. The machine of claim 12 wherein the portion is a push lug of the conveyor.

14. A method of calibrating a package wrapping machine that includes a conveyor for moving trayed items from an infeed station toward a wrap station, the machine further including a controller for controlling operation of the machine, the method comprising the controller:
monitoring an indicator of motor rotation of a motor that drives the conveyor as a portion of the conveyor is moved from a first position to a second position;
utilizing the indicator to store a calibration value for future use during trayed item wrapping operations.

15. The method of claim 14 wherein (i) the indicator is used to determine a distance between the first position and the second position, and the distance is stored in memory as the calibration value or (ii) the indicator is an encoder tick count and the encoder tick count is stored as the calibration value.

16. The method of claim 14 wherein:
the portion of the conveyor comprises a push lug of the conveyor;
the controller detects location of the push lug at the first position via a first sensor;
the controller detects location of the push lug at the second position via a second sensor.

17. The method of claim 16 wherein:
the first sensor comprises a Hall sensor that detects a magnet on the push lug;
the second sensor comprises a light beam that is broken when the push lug reaches the second position.

18. The method of claim 14 wherein the calibration is carried out without conveying any trayed item on the conveyor and without requiring input of tray size information to a user interface of the machine.
